(19) United States
(12) Patent Application Publication
(10) Pub. No.: US 2004/0049386 A1
(43) Pub. Date: Mar. 11, 2004

(54) Speech recognition method and system for a small device

(76) Inventor: Meinrad Niemoeller, Holzkirchen (DE)

Correspondence Address: BELL, BOYD & LLOYD, LLC, P. O. BOX 1135, CHICAGO, IL, 60690-1135, US

(21) Appl. No.: 10/450,580

(22) PCT Filed: Dec. 12, 2001
(86) PCT No.: PCT/EP01/14616

(30) Foreign Application Priority Data
Dec. 14, 2000 (EP) 00127457.0

(51) Int. Cl. G10L 15/00

(52) U.S. Cl. 704/235

(57) ABSTRACT

The invention relates to a speech recognition method for a small device (MS, T) that is connected to a telecommunications network or to a data network (GSM, TN), whereby the method involves a recognition of letter strings or character strings, which are composed of spoken individual letters or characters, as words that are output as written words and/or are used for controlling purposes. The recognition of the letter strings or character strings is performed, at least in part, in a central server (PRO) that is connected to the small device via the telecommunications network or data network.

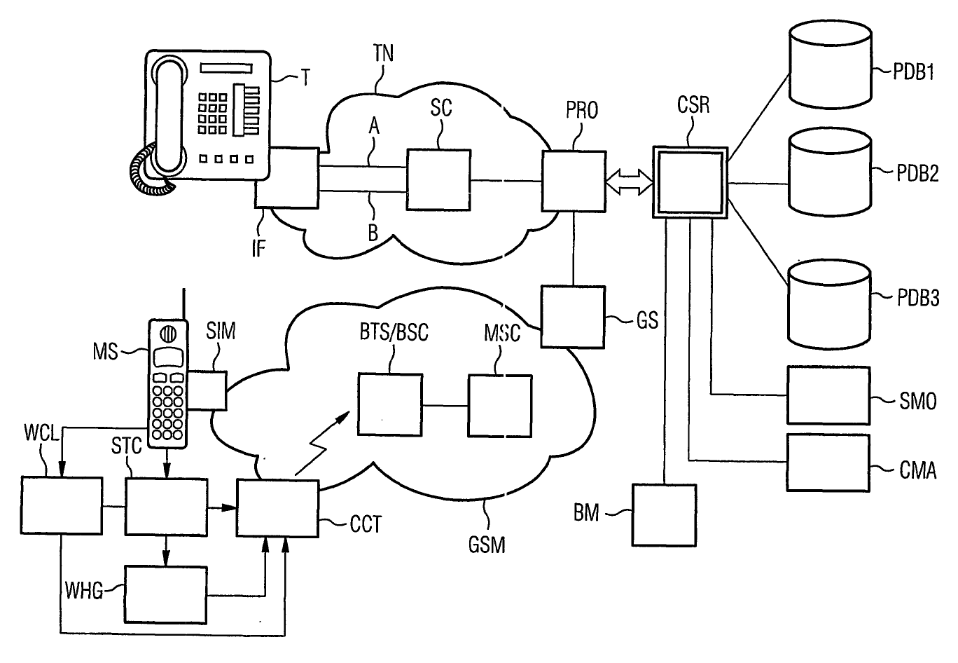

The invention relates to a speech recognition method for a small device that is connected to a telecommunications network or to a data network in accordance with the precharacterizing clause of claim 1, and also relates to a corresponding system and a corresponding device.

Small electronic devices, whose success in the field of consumer electronics began with the portable or pocket transistor radio and continued impressively with the Walkman and later the Discman in the area of audio devices and also with pocket computers and pocket translators as well as databases in the area of data processing and data storage devices, are ever increasing in power and complexity and in part place particularly high demands on the operating dexterity of the user. Intelligent interactive systems such as are used today in the case of complex small devices such as mobile telephones or handheld PCs also still place relatively high demands on the skills and the patience of their users in respect of their operation. The introduction of speech recognition for controlling such devices is therefore particularly in the interests of very busy users on the one hand whose main application is professional, and of older people and children on the other hand.

Small devices with voice control—particularly in the form of mobile telephones—are already known and available on the market. However, in spite of all the progress made in processor and memory technology, the speech recognition systems implemented in that situation are unable to attain the performance of the speech recognition systems such as are used in the case of PCs for example for text input, on account of the necessarily limited processing and memory capacity of small devices. In many cases, only vocabularies of several hundred words can currently be implemented. In this situation, the general problem of recognition errors relating to the speaking of unknown words which is experienced with all speech recognition systems is particularly serious.

In human communications, for centuries people have resorted to spelling in order to recognize unknown words and forms of writing. However, the error rate when simply enunciating a string of letters is relatively high even during human communications, and current speech recognition systems yield even less satisfactory results. In particular, letter groups such as the groups c, b, d, e, g, p, t, w or m, n or a, h, k involve great danger of confusion because they sound very similar [in German].

With regard to a string of letters, however, a person can usefully apply his feeling for language and knowledge of context and rule out clearly or probably meaningless combinations of letters that result from the incorrect recognition of individual letters in a string and “imagine” meaningful combinations in their place. In addition to the aforementioned contextual knowledge, a knowledge of probable letter strings and of redundancies in words are also of assistance to a person. As a result, the error rate when spelling is considerably reduced in human communication.

A method is also known with regard to speech recognition systems of utilizing the probability of certain strings of letters for the recognition of spoken words which are spelled out. Corresponding systems have moreover already been used for some time in the case of mobile telephones for entering short messages (SMS) by way of the keypad and have proven themselves in that situation. In principle, the use of contextual knowledge in speech recognition systems is also possible but this does require extremely high storage capacities and is therefore not currently a practical solution for implementation in small devices.

The object of the invention is therefore to provide a generic method and also a corresponding system which can be used to substantially improve the recognition of spoken letter strings or character strings at a justifiable level of resource utilization.

This object is achieved in respect of its method aspect by a method having the features described in claim 1 and in respect of its equipment aspect by a system or a small device having the features described in claim 11.

The invention incorporates the fundamental concept of moving at least those steps involved in the recognition process of a letter string spoken on a small device which have a high storage space requirement out of the small device. Furthermore, the invention incorporates the concept for these parts of the method of using a central server, located in the telecommunications or data network, which has practically unlimited capacity at its disposal for this purpose. By preference, only a simple letter string recognition facility remains on the small device, for which little processing power and storage space are required and which therefore can also be implemented using microcontrollers and DSPs (digital signal processors) of the aforementioned small devices.

Through the use of background or contextual knowledge on the server, extremely good recognition performance results can then also be obtained at the word level if an extremely high error rate occurred during the preceding initial letter string recognition. In accordance with the aforementioned task distribution between the small device as a client and the central server, the preferred embodiment of the invention therefore provides for a speech-to-text conversion of the spoken letter strings or character strings into a provisional written letter string or character string on the small device, followed by transfer of the letter string or character string to the server, then checking and if necessary correcting this letter string or character string on the server and transferring the checked letter string or character string back to the small device, after which a further simple processing step in the form of a confirmation of the received word can be performed on the small device.

In a modified embodiment, the method provides for the fact that the recognition is actually completed on the server and the final word is transferred back to the small device, received by the latter and stored on the latter. Naturally, it makes sense for storage to also take place on the small device if the final fixing of the recognized word takes place there.

The execution of the principal method component situated on the server takes place in particular using one or more letter confusion matrices or a letter speech model, whereby the latter can utilize complex algorithms and extensive context databases as a result of the practically unlimited resources offered by the server.

In a further preferred embodiment of the invention, a word classifier is entered by the user on the small device in conjunction with the letter string or character string and is transferred together with the provisional written letter string or character string to the server where it is used as supplementary information for the recognition process taking place there (checking and, if necessary, correction). In the small device, a so-called word hypothesis graph is formed in particular from the letter string search and transferred to the server, and a search is performed on the server on this word hypothesis graph in a text dictionary database with a plurality of storage areas or in a plurality of text dictionary databases.

With regard to the word classes specified by the word classifier, these can for example be people's names, street names or place names, or Internet addresses, or even specialist terminology for a particular field or similar, for which a directory or dictionary is maintained on the server in each case. The centralized processing here also offers the special advantage of uncomplicated updating and maintenance of the data inventory—which is extremely important in view of the rapidly growing number of domain names particularly for Internet addresses.

In a variant which is of particular interest to the business community the proposed method is implemented as a service of a telecommunications company or a service provider and as such is offered to the users as a chargeable service in particular, and in some cases even as a non-chargeable service.

Depending on the concrete implementation of the telecommunications network or data network and of the associated terminal device, the mostly highly developed resources available are preferably used in each case for transferring the entered new words to the server. In the case of a mobile telephone connected to a mobile radio network in accordance with the GSM standard, the transmission preferably takes place as a short text message using SMS, and in the case of a WAP-enabled mobile telephone the transmission preferably takes place as a text message in accordance with the WAP standard. With regard to future mobile radio standards, their protocols will offer corresponding capabilities—in particular for a UMTS network the transmission will be possible by means of a standard Internet protocol (HTTP). In the case of a fixed-network telephone connected to an ISDN network, the transmission takes place by way of a data channel of the ISDN network. In this case, the input is preferably made (as in the case of the mobile telephone) by way of an alphanumeric keypad or by multifrequency code.

In addition to the aforementioned embodiments, the small device can in particular also take the form of a handheld PC or PDA for connection to a telecommunications network and/or data network, or also of a mobile input unit for a remote-operation control system.

In particular it has a display facility designed for displaying a plurality of letter strings or character strings and a confirmation facility for confirming a word recognized on the server. This can in particular be implemented as a soft key in conjunction with a menu-driven control system or on a touch screen.

Advantages and suitabilities of the invention are moreover set down in the subclaims and also in the description which follows of a preferred embodiment with reference to the FIGURE.

The FIGURE shows—in a synoptic representation which, however, given the existence of the economic prerequisites is also technically capable of implementation—preferred embodiments of the invention on an ISDN fixed-network telephone T and a GSM mobile telephone MS which are connected to a landline telephone network TN and a mobile radio network GSM respectively, operating in conjunction with a letter string recognition facility CSR which is assigned jointly to both the communications networks TN and GSM. The fixed-network telephone T and the mobile telephone MS are each linked by way of an ISDN telephone line ISDN and (not separately designated) an air interface and also a base station BTS/BSC respectively to a respective switching center SC or MSC for their network. By way of this switching center, a link is established directly (in the case of the fixed network) or indirectly by way of an additional gateway server GS to a common management and service center PRO belonging to a service provider, which offers a transcription service as a chargeable service both in the fixed network TN and also in the mobile radio network GSM.

Internal signal processing components which are involved in the overall process of letter string recognition are represented in broad outline in the FIGURE for the mobile telephone MS; the fixed-network telephone T can naturally also have analog components. In this situation, these are a speech-to-text converter STC for converting the spoken letter strings into letter strings in text form, a word hypothesis graph WHG linked to the latter and also a word classifier WCL linked to the input keypad, and finally a letter string transmission stage CCT which is fed by the components mentioned at the beginning.

Assigned to the letter string recognition facility CSR are a plurality of text dictionary databases PDB1 through PDB3 and also (represented schematically in the form of two function blocks) a letter confusion matrix CMA and also a letter speech model SMO for analysis purposes. Furthermore, a charge metering facility BM is assigned to the letter string recognition facility for charging for usage of the transcription service.

In the case of the fixed-network telephone T an ISDN interface facility IF is incorporated which is shown symbolically in the FIGURE simply as a separate block. The ISDN line between the fixed-network telephone T and the associated switching center SC has a voice channel A and an independent data channel B in the known manner.

As mentioned above, after the speech-to-text conversion has taken place in the speech-to-text converter STC and by using the word hypothesis graph WHG a provisional letter string recognition process is performed in the mobile telephone for words spelled out by the user. The recognition result is transmitted by way of the letter string transmission stage CCT together with the word classifier entered by the user via the keypad to the management and service center PRO belonging to the provider and to the letter string recognition facility CSR connected to it there. The latter, by accessing the reference dictionary databases PDB1 through PDB3, the letter confusion matrix CMA and the letter speech model SMO, performs a check on the letter string output by the mobile telephone, using a comprehensive linguistic background and contextual knowledge of the respective national language of the user. In this situation, the selection of the national language is carried out on the basis of the user data stored in the SIM card and/or on the basis of a selection made by the user at the beginning of the corresponding menu. Pronunciations of characters, spelling habits etc. that are typical of national languages are naturally taken into consideration in this situation.

If the check yields the result that significant probabilities exist for letter strings other than the provisional letter string output by the mobile telephone, that is to say words that are spelled differently, then all these words are transmitted back to the mobile telephone and displayed on the latter's display together with a selection prompt directed at the user. After the user has made his selection by activating a soft key, the relevant word is defined and is included in the internal vocabulary memory. (It is also possible for only the letter string or word having the highest probability determined by the letter string recognition facility to be transmitted back to the mobile telephone and processed and (optionally) stored there as the final result of the recognition operation.)

The checked letter string recognition works analogously for letter strings spoken into the fixed-network telephone T. The return transmission of the checked and, if necessary, corrected letter string or strings is carried out in this case in particular by way of the B channel of the ISDN network. A preselection or confirmation of the knowledge sources to be used during the central checking carried out by the letter string recognition facility CSR can also be made here by the user, or these are selected in accordance with the national or local dialing code for the user of the fixed-network telephone.

The embodiment of the invention is not restricted to this example but can also comprise a large number of variations which fall within the scope of expert action.

1. Speech recognition method for a small device (MS, T) that is connected to a telecommunications network or to a data network (GSM, TN), whereby the method involves a recognition of letter strings or character strings, which are composed of spoken individual letters or characters, as words that are output as written words and/or are used for control purposes,
characterized in that
the recognition of the letter strings or character strings is performed, at least in part, in a central server (PRO) that is connected to the small device via the telecommunications network or data network.

2. Method according to claim 1,
characterized in that
a speech to text conversion of the spoken letter string or character string into a provisional written letter string or character string is performed in the small device (MS, T),
the provisional written letter string or character string is transmitted to the central server (PRO),
the provisional written letter string or character string is checked and, if necessary, corrected in a second transformation step on the server, using a letter confusion matrix (CMA) and/or a letter speech model (SMO), and the word is created, and
the word is transmitted back to the small device and is received by the small device where it is processed and/or stored.

3. Method according to claim 1,
characterized in that
a provisional speech-to-text conversion of the spoken letter string or character string into a provisional written letter string or character string is performed in the small device (MS, T) in a first transformation step,
the provisional written letter string or character string is transmitted to the central server,
the provisional written letter string or character string is checked and, if necessary, corrected in a second transformation step on the server, using a letter confusion matrix and/or a letter speech model, and at least one checked and corrected letter string or character string is created,
the checked letter string or character string or the checked letter strings or character strings are transmitted back to the small device and are received by the small device, and
in the small device in a third transformation step the word is formed from the checked letter string or character string or from the checked letter strings or character strings, and is stored and/or processed.

4. Method according to one of the preceding claims,
characterized in that
a word classifier is entered on the small device (MS, T) in conjunction with the letter string or character string,
the word classifier is transferred together with the provisional letter string or character string to the server (PRO) and is evaluated as supplementary information for the recognition process.

5. Method according to claim 4,
characterized in that
a word hypothesis graph is formed in the small device (MS, T) from the letter string recognition and is transferred to the server (PRO), and a search is performed on the server on the word hypothesis graph in a text dictionary database using a plurality of storage areas, each assigned to a word class.

6. Method according to one of claims 3 to 5,
characterized in that
the checked letter string or character string, or checked letter strings or character strings, is/are displayed on the small device (MS, T) for final definition by the user.

7. Method according to claim 6,
characterized in that
the display of the letter strings or character strings takes place in the sequence of their probability determined by the server.

8. Method according to one of the preceding claims,
characterized in that
the section of the recognition process running on the server (PRO) is organized as a service in the telecommunications or data network.

9. Method according to one of the preceding claims,
characterized in that
the transmission from and to a mobile radio terminal device (MS) takes place as a short message or by way of the WAP using a mobile radio network (GSM), particularly having regard to a connection to an IP network.

10. Method according to one of claims 1 to 8,
characterized in that
the transmission from and to a fixed-network telephone (T) takes place by way of an ISDN data channel (B) of an ISDN fixed network (ISDN).

11. System for executing the method according to one of the preceding claims,
characterized by
a plurality of terminal devices (MS, T) connected to the telecommunications network or data network (GSM, ISDN), and
a server (PRO) connected to a services center in the telecommunications network or data network, which has means (CSR) for recognition of the letter string or character string.

12. System according to claim 11,
characterized in that
the means (CSR) for recognition of the letter string or character string comprise at least one letter confusion matrix (CMA) and/or at least one letter speech model (SMO).

13. System according to claim 11 or 12,
characterized in that
a charge metering facility (BM) assigned to the server (PRO) for charging for the section of the recognition process for the letter string or character string which is handled by the server as a service.

14. System according to one of claims 11 to 13,
characterized in that
the small device is designed as a mobile radio terminal device (MS) which is connected by way of a mobile radio network (GSM) to the server, particularly having regard to a connection to an IP network.

15. System according to one of claims 1 to 14,
characterized in that
the small device is designed as a fixed-network telephone (T) which is connected by way of an ISDN data channel (B) of an ISDN fixed network (ISDN) to the server.

16. System according to one of claims 11 to 15,
characterized in that
the small device is designed as a data processing or operating device, in particular as a handheld PC or mobile input unit for a remote-operation control system, which is connected to the server by way of a telephone fixed network, in particular an ISDN fixed network, a mobile radio network or a data network.

17. System according to one of claims 11 to 16,
characterized in that
the small device has a display facility designed for displaying a plurality of letter strings or character strings and a confirmation facility for final definition of the word recognized on the server.

18. System according to claim 17,
characterized in that
the display facility is designed for displaying the letter strings or character strings in accordance with their probability determined by the server.

19. System according to claim 17 or 18,
characterized in that
the confirmation facility has a touch screen or a menu-driven control system in conjunction with an Enter key, in particular a soft key.
